(19) United States
(12) Patent Application Publication
(10) Pub. No.: US 2019/0308138 A1
(43) Pub. Date: Oct. 10, 2019

(54) Simple application of surface coating based on a formulation containing additive to remove air pollutants.

(71) Applicant: George Maguire, Greensboro, NC (US)

(72) Inventor: George Maguire, Greensboro, NC (US)

(21) Appl. No.: 16/373,108

(22) Filed: Apr. 2, 2019

Related U.S. Application Data
(60) Provisional application No. 62/653,280, filed on Apr. 5, 2018.

(51) Int. Cl. B01D 53/88; B01D 53/86; B01D 53/02; C04B 41/50

(52) U.S. Cl. CPC B01D 53/885; B01D 53/8675; B01D 53/02; C04B 41/5025; B01D 2259/4558; B01D 2257/502; B01D 2279/40; B01D 2253/108; B01D 2253/25; B01D 2257/106; B01D 2257/702

(57) ABSTRACT

Simple application of surface coating based on a formulation containing additive to remove air pollutants is disclosed. This improved surface wash, surface coating, windscreen wash, windscreen coating, is applied as a surface coating, wash or treatment to automotive vehicles, during regular periodic intervals, wherein vehicle is washed, and surface coating applied and also applied as window wash as needed. And as such method is very well distributed geographically. This invention avoids complexities involved in operation of existing methods, where heavy, expensive equipment and complex operation is prevalent. The invention is simple enough such that human error is effectively avoided.

### CROSS-REFERENCES TO RELATED APPLICATIONS:

Prior-filed provisional applications: 62/653280.

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC

“Not Applicable”

### BACKGROUND OF THE INVENTION

Background of the Invention in two parts:

### Field of the Invention

Art Unit 1736, Class 588, Class Title HAZARDOUS OR TOXIC WASTE DESTRUCTION OR CONTAINMENT, Subclass Ranges From 1 (and 261) to Subclass Ranges To 20 (and 000).

### Description of the Related Art

A review of literature relating to pollution control reveals references which are known which disclose proactively cleaning the environment. U.S. Pat. No. 3,684,741, Patented Aug. 15, 1972, discloses a supported catalysts for the oxidation of aromatic or unsaturated aliphatic hydrocarbons to carboxylic acids or anhydrides. But does not claim application to mobile structures or windows of static structures U.S. Pat. No. 3,738,088 discloses a MOBILE AIR CLEANING APPARATUS FOR POLLUTION REMOVAL; U.S. Pat. No. 5,861,205 discloses NOₓ-CLEANING PAVING BLOCK; But does not claim windshield application and subsequent re-application from windshield washer as does likewise: U.S. Pat. No. 6,340,066 B1 which discloses POLLUTANT TREATING DEVICES AND METHODS OF MAKING THE SAME, and U.S. Pat. No. 8,899,871 B2 which discloses EMBEDDING PHOTOCATALYTIC TITANIUM DIOXIDE IN ASPHALT SURFACES TO REDUCE POLLUTANTS VIA PHOTOCATALYTIC REACTIONS

U.S. Pat. No. US 2002/0074174 A1 discloses POLLUTANT TREATING DEVICES AND METHODS OF MAKING THE SAME, a pollutant treating device especially adapted for motor vehicles in which a housing containing a catalyst composition for treating pollutants is positioned within the normal flow pattern of ambient air within the motor vehicle, and similarly U.S. Pat. No. US 2003/0166466A1 discloses CATALYST AND ADSORPTION COMPOSITIONS HAVING IMPROVED ADHESION CHARACTERISTICS, a method for improving the adhesion of catalytic and adsorptive compositions to surfaces is disclosed, though claims referring to mobile vehicle applications is extant, it does not however claim windshield application and subsequent re-application form windshield washer.

World Pat. No. WO 96/22146 discloses CLEANING AMBIENT AIR BY MOVING VEHICLE HAVING A POLLUTANT TREATING SURFACE THROUGH THE ATMOSPHERE, the method recited in claim 57 describes the atmosphere contacting surface as a wind deflector. A wind deflector in this application is nowhere described as glass, or a windshield, an does not claim windshield application and subsequent application form windshield wash(er).

Korean Pat. No. KR100470857 discloses Cleaning Ambient Air by the Movement of a Vehicle Having a Pollutant Treating Surface, wherein at least one air contacting surface and air processing method and apparatus comprising a vehicle having a pollutant treating composition located on said surface by moving through the air. Specific embodiments include those for coating a motor vehicle radiator with pollutant treating catalyst, the wind deflector surface referenced is defined as being specific to trucks and is the deflector on top of cabin roof used to provide improved aerodynamics.

Reaction chemistry involved in CO₂ removal is well defined in the following peer reviewed publication: Modeling and Experimental Study of CO₂ Removal by Alkanolamines in a Packed Bed, Amir Rahimi et al. Department of Chemical Engineering, College of Engineering, University of Isfahan, Isfahan , Iran. Accepted author version posted online: 17 Oct. 2013.Published online: 17 Jan. 2014. Study of CO₂ Removal by Alkanolamines in a Packed Bed, Separation Science and Technology, 49:3, 317-328.

### BRIEF SUMMARY OF THE INVENTION

Ambient air pollutants are highly prevalent and increasing with time. Current methods rely on equipment that are costly and a process that is labor intensive. This improved surface wash, surface coating, windscreen wash, windscreen coating, is applied as a surface coating, wash or treatment to automotive vehicles, during regular periodic intervals, wherein vehicle is washed, and surface coating applied and also applied as window wash as needed. And as such method is very well distributed geographically.

This invention avoids complexities involved in operation of existing methods, where heavy, expensive equipment and complex operation is prevalent. The invention is simple enough such that human error is effectively avoided.

After a nominal interval of time surface coating is removed from vehicle by normal washing, and reapplication of novel coating gives continuous, removal of pollutants. Waste wash water is disposed of as per normal processes, given pollutant is bound additive.

Continuous refilling of wind-screen wash with additive composition ensures continuous periodic removal of pollutants.

Additional cost of additive to existing technology should be minimal given the wide distribution and adoption of users of the technology.

### BRIEF DESCRIPTION OF THE SEVERAL VIEWS OF THE DRAWING(S)

“Not Applicable”

### DETAILED DESCRIPTION OF THE INVENTION

Ambient air pollutants are highly prevalent and are increasing with time. The invention claimed here solves, at least in part, this problem. A conventional automotive vehicle, defined as a vehicle propelled through time and space by motorized means, where addition of coating or wash comprising an active additive or additives that bond, absorb, adsorb or otherwise remove air pollutants under ambient conditions, that according to the invention, by adding from 0.1 to 99.9 percent by weight chosen from a list of chemicals well known to those skilled in the art. The active additive will coat vehicle and remain on vehicle upon completion of surface application, including simple wash/rinse.

Surface coating may be temporary or permanent. Permanent coating is designed to react with pollutant making pollutant benign and easily removed as pollutant bound, absorbed, adsorbed to active chemical component(s) product by simple washing.

Temporary coating is designed to capture, or react to provide benign reaction products with, pollutants. This improved surface wash, surface coating, windscreen wash, windscreen coating, is applied as a surface coating during regular periodic intervals. The active additive will coat vehicle and remain on vehicle until normal washing cycle is complete. Reapplication of surface coating gives continuous removal of pollutants.

Continuous refilling of windscreen wash with additive composition under normal operation conditions ensures continuous, periodic removal of pollutants.

The present claimed invention is an improvement on what currently exists. The approach currently in use to capture of air pollutants are only locally distributed and thus the amount of pollutant captured is limited. Further distribution of existing technology is prohibited by high cost. The present claimed invention spreads the cost among individuals, of whom will encounter only a small fractional increase in existing costs. Additional cost of additive to existing technology should be minimal given the wide distribution and adoption of users of the technology.

The scale of the current methods are small and only capture a very small fraction of air pollutants. This improved surface wash, surface coating, windscreen wash, windscreen coating, is applied as a surface coating, wash or treatment to automotive vehicles, during regular periodic intervals, wherein vehicle is washed, and surface coating applied and also applied as window wash as needed. And as such method is very well distributed geographically.

The present claimed invention avoids complexities involved in operation of existing methods, where heavy, expensive equipment and complex operation is prevalent. The invention is simple enough such that human error is effectively avoided.

After a nominal interval of time surface coating is removed from vehicle by normal washing, and reapplication of novel coating gives continuous, periodic removal of pollutants. Waste wash water is disposed of as per normal process, given pollutant is bound additive. The waste effluent provided by simple washing of, or application of, automotive vehicle surface coating, which contains active additive may be collected and used in further chemical treatment providing further air pollutant removal.

The present claimed invention is illustrated by the following example.

### EXAMPLE 1

### An Automotive Windshield Wash Formulation

Ethanolamine (HOCH₂CH₂NH₂) solution (10% by mass in methanol) was fed to top of a glass absorption column (1.55 m high, 0.092 m inside diameter) packed with 6 mm ceramic Raschig rings. The bed consisted of a 0.82 m long column. Gas flow of CO₂ was 20 L/min at 10% concentration in nitrogen fed to bottom of column; liquid flow rate for ethanolamine methanol solution was 1 L/min, fed to top of column. Detection of CO₂ at top of column showed drop in relative CO₂ concentration from 100 to 0.48. The reaction involved here is as follows:

HOCH₂CH₂NH₂ (Ethanolamine)+CO₂→HOCH₂CH₂NHCO₂⊖(stable carbamate)+HOCH₂CH₂NH₃⊕

1. A temporary surface treatment containing 0.1 to 99.9 percent by weight of additive or additives, chosen from a list of chemicals well known to those skilled in the art, known to bond, absorb, adsorb or otherwise capture air pollutants under ambient conditions is applied to a solid surface which is exposed to the atmosphere, a window surface, both moving, as in a vehicle windshield, or a stationary structure, is envisioned here, wherein the list of compounds may contain, but is not limited to an aqueous solution, or aqueous glycol solution, of organic nitrogen compounds selected from, but not limited to, the group consisting of 2-amino-2-methyl-1,3-propanediol, 2-amino-2-ethyl-1,3-propanediol, 2-amino-2-methyl-1-propanol, t-butyldiethanolamine, and 2-amino-2-hydroxmethyl-1,3-propanediol; and 1-25 parts by weight of amine selected from the group consisting of piperazine, piperidine, morpholine, glycine, 2-methylaminoethanol, 2-piperidineethanol, 2-ethylaminoethanol, tetraethylenepentamine (TEPA), methydiethanolamine (MDEA), Triethylammonium hydrogen sulfate [Et₃N][HSO₄], Ionic Liquids (Deep Eutectic Solvents) containing organic nitrogen compounds, mixed aqueous solution of zeolites, from kaolin, impregnated with preceding organic nitrogen compounds and other compounds known to those skilled in the art.

2. Removal of temporary surface treatment additive containing captured pollutant, according to claim 1. above, is accomplished by washing surface as is normally done, periodically.

3. Reapplication of temporary surface treatment, according to claim 1. above, may be accomplished as part of the wash cycle according to claim 2. above, or may be reapplied independent of wash.

4. The cycle as according to claim 1., claim 2., and claim 3. above, may be repeated at will, allowing for the simultaneous and periodic removal of pollutant or pollutants.

5. An automative vehicle windscreen wash containing additives according to claim 1. above, during normal operation will deposit additive on windscreen, and during routine operation will wash off additive containing captured pollutant or pollutants. This cycle may be repeated at will allowing for the simultaneous removal of pollutant or pollutants and reapplication of windshield treatment

6. An additive, or additives, as in claim 1., from a complete list of chemical additives, capable of capturing pollutants by absorbing, adsorbing, bonding, or other surface-active method, pollutants include, but are not limited to, carbon dioxide, carbon monoxide, ozone, and other airborne pollutants, at ambient temperature and pressure.

7. Application of additive or additives described herein to surface is essential for invention to work.

8. Each element described could be performed alone or in conjunction in any combination.
